(19) United States
(12) Patent Application Publication
(10) Pub. No.: US 2015/0304293 A1
(43) Pub. Date: Oct. 22, 2015

(54) MESSAGE AUTHENTICATION SYSTEM AND MESSAGE AUTHENTICATION METHOD

(71) Applicant: NEC Corporation, Tokyo (JP)

(72) Inventor: Toshihiko OKAMURA, Tokyo (JP)

(73) Assignee: NEC Corporation, Tokyo (JP)

(21) Appl. No.: 14/442,001

(22) PCT Filed: Nov. 7, 2013
(86) PCT No.: PCT/JP2013/006564

§ 371 Date: May 11, 2015

(30) Foreign Application Priority Data
Nov. 13, 2012 (JP) 2012-249559

(51) Int. Cl. H04L 29/06; H04L 1/00

(52) U.S. Cl. CPC H04L 63/08; H04L 63/06; H04L 1/0041

(57) ABSTRACT

The message authentication system is a message authentication system used in a multihop network and including a server 30 and multiple nodes 1 which transmit data to the server 30. Each of the nodes 1 includes: a tag generation unit 902 which uses a private key shared with the server to calculate a tag as a message authenticator corresponding to the data; and a parity tag generation unit 901 which uses the tag to generate a parity tag composed of parities calculated as error-correcting code. The node 1 generates the parity tag corresponding to the tags created by the node 1 and child nodes of the node 1, and transmits the parity tag to a parent node or the server 30 together with the data.

### TECHNICAL FIELD

The present invention relates to a message authentication system and message authentication method for detecting the falsification of data, and particularly to a message authentication system and message authentication method in multihop network communication.

### BACKGROUND ART

One of the aims of information security technology is to ensure integrity. Therefore, the information security technology is required to be able to verify that received data are data from a transmitter. As a method of achieving the verification, a technique called message authentication is generally used, where a transmitter and a receiver have a common private key, and the receiver uses a block cipher or a hash function to confirm that data are from the transmitter having the private key.

FIG. 10 is an explanatory diagram showing processing performed by a transmitter and a receiver in general message authentication. Tag generation means 101 uses a private key to generate a tag (authenticator) corresponding to data to be transmitted, and transmits a generated tag 103 together with the data. Like the transmitter, the receiver uses tag generation means 102 to generate a tag 104 based on the received data and a private key owned. Then, the receiver checks whether the generated tag 104 matches the received tag 103. When the tags match with each other, the receiver determines that the received data are correct, while when the tags do not match, the receiver determines that the data have been falsified or the like, and discards the data.

A tag is denoted by T and the other data are denoted by D below. It is common practice to generate the tag by adding, to D, an initial vector (hereinafter denoted by IV) such as a counter value or a random number as well as user data in order to increase security. In the following description, it is assumed that transmitted data include IV as necessary.

In the message authentication, encryption is often performed at the same time. In this case, the tag generation means 101 on the transmitting side encrypts data, and the tag generation means 102 on the receiving side performs decryption processing on the encrypted data. There are a method in which a private key used for encryption is set independently of a private key for message authentication, and a method in which the private key used for encryption is identical to the private key for message authentication.

The tag generation is required to have such properties that make it difficult to estimate a tag from data when the private key is unknown and that make it difficult to estimate the private key even when pairs of data and tags are gathered. As the tag generation system, Non Patent Literature (NPL) 1 describes a system using a block cipher. Further, NPL 2 describes a system using a hash function.

In data communication, the use of a sensor network is promoted. In the sensor network, many small-scale devices such as sensors are arranged. Measured data are aggregated on a server by wireless communication. As a communication system applied when the power consumption and size of a sensor device take priority, there is a multihop network in which data are transmitted to the server via adjacent devices. FIG. 11 is an explanatory diagram showing an example of the multihop network. Node 1 to node 19 shown in FIG. 11 are devices such as sensor devices having the function of measuring information and performing communication. Respective nodes constitute a network of a tree structure having the server as the root. The server and each node communicate via some nodes according to the network configuration. In FIG. 11, for example, data of node 9 are transmitted to the server via intermediate node 8, intermediate node 6, and intermediate node 1.

Hereinafter, nodes (including an own node) that constitute a subtree having a certain node (the own node) as the root are called descendant nodes, and nodes exclusive of the own node in the descendant nodes are called child nodes. Further, an upper node linked to a certain node (i.e., one closer to the server) is called a parent node. In FIG. 11, descendant nodes of node 6 are node 6, node 7, node 8, node 9, node 10, and node 11, and node 6 relays and transmits all data of these nodes. The speed of wireless communication configuring the multihop network is generally low, and it is desired to reduce communication traffic between intermediate nodes in order to reduce communication power consumption.

As an example of the application using the multihop network shown in FIG. 11, there is a smart meter system which automatically reads electricity or gas meters. In the smart meter system, specified low-power radio or the like is applied as wireless communication. In the smart meter system, since charging and control are performed based on the measurement results, the falsification of data has a large impact on the system. To prevent this, message authentication is applied.

In a sensor network such as the smart meter system, nodes measure data at determined times. Then, the scheduled measurements to transmit the data to the server are made as principal business activities. For example, a meter is read every 30 minutes, and the data are transmitted to the server. Although the amount of data for one scheduled measurement is small, the addition of a tag for message authentication can lead to a large increase in communication traffic. Data transmitted together with the tag from a node in the scheduled measurement typically include IV, ID of the node, the measurement time, and measured data. A tag of 64 bits or more is generally required to ensure the security of message authentication. In this case, for example, if each piece of data other than the tag is of 32 bits, respectively, the size of tag will be one third of the total data (tag and data) size, accounting for a large proportion.

As a system for reducing the communication traffic of message authentication tags in the multihop network, a system called Aggregate MAC (Message Authentication Code) described in NPL 3 is known. In this system, the exclusive OR of tags of descendant nodes is computed at an intermediate node to transmit the tag. In the following description, this tag is called an aggregate tag.

FIG. 12 is a block diagram showing the configuration of a node using Aggregate MAC. The node shown in FIG. 12 includes aggregate tag generation means 301, tag generation means 302, a data memory 303, reception processing means 304, and transmission processing means 305. The reception processing means 304 receives data from a child node to perform buffering and the like. The transmission processing means 305 configures data to be transmitted to a parent node. The data memory 303 is a memory for storing data measured at the node. Like the tag generation means 101 or the tag generation means 102 shown in FIG. 10, the tag generation means 302 uses a private key to generate a tag (authenticator) corresponding to data, and transmits the generated tag together with the data.

Hereinafter, a tag of node n is denoted by T(n), data of the node n is denoted by D(n), and an aggregate tag of the node n is denoted by A(n). For example, in the example shown in FIG. 11, an aggregate tag of node 8 becomes the exclusive OR of tags of node 8, node 9, and node 10 as expressed in Equation (1).

A(8)=T(8)+T(9)+T(10). (1)

Further, in the example shown in FIG. 11, A(n)=T(n) at a terminal node such as node 3, node 5, or node 7.

The aggregate tag generation means 301 uses tag T(8) of the own node, which is generated by the tag generation means 302 using tag T(9) and tag T(10) of node 9 and node 10 to perform processing shown in Equation (1) in order to generate A(8). The transmission processing means 305 transmits data D(8), data D(9), data D(10), and aggregate tag A(8).

A(6) is the exclusive OR of tags of node 6, node 7, node 8, node 9, node 10, and node 11, which is expressed by using A(8) as shown in Equation (2). The node 6 transmits data D(6), data D(7), data D(8), data D(9), data D(10), data D(11), and aggregate tag A(6).

A(6)=T(6)+T(7)+A(8)+T(11). (2)

In the system using Aggregate MAC as mentioned above, since the intermediate node has only to transmit only one tag irrespective of the number of descendant nodes, tag communication traffic can be reduced. In the system using Aggregate MAC, a server uses a private key corresponding to each node to calculate tag T from received data, and XORs all tags to calculate an aggregate tag. Then, the server compares the calculated aggregate tag with the received aggregate tag to authenticate the whole received data.

### CITATION LIST

### Non Patent Literatures

NPL 1: NIST Special Publication 800-38B, “Recommendation for Block Cipher Modes of Operation: The CMAC Mode for Authentication,” May 2005.
NPL 2: FIPS PUB 198-1, “The Keyed-Hash Message Authentication Code (HMAC),” July 2008.
NPL 3: Jonathan Katz and Andrew Y. Lindell, “Aggregate Message Authentication Codes,” RSA Conference (CT-RSA) '08.

### SUMMARY OF INVENTION

### Technical Problem

The system using Aggregate MAC can reduce an increase in communication traffic due to the addition of message authentication tags. However, in such a system, when the aggregate tags do not match on the server, the system can only detect that data of either node or the aggregate tag have been falsified or an error has occurred therein, and there is a problem that the node that has caused the error cannot be identified. For example, even when an error has occurred such as the falsification of data of one node or a mismatch between private keys, the server performs processing such as to take the procedure for requesting retransmission of data from all the nodes after the verification of the aggregate tag. For example, when a mismatch between private keys has occurred, a procedure for transmitting data from each node without any aggregate tag, or the like is required to identify the node.

It is an exemplary object of the present invention to provide a message authentication system and message authentication method capable of reducing an increase in communication traffic due to tags, and when an error has occurred due to the falsification of data or a mismatch between private keys, which can identify a node that has caused the error.

### Solution to Problem

The message authentication system according to the present invention is a message authentication system used in a multihop network and including a server and multiple nodes which transmit data to the server, wherein each of the nodes includes: tag generation means for using a private key shared with the server to calculate a tag as a message authenticator corresponding to the data; and parity tag generation means for using the tag to generate a parity tag composed of parities calculated as error-correcting code, wherein the node generates the parity tag corresponding to the tags created by the node and child nodes of the node, and transmits the parity tag to a parent node or the server together with the data.

The message authentication method according to the present invention is a message authentication method used in a message authentication system used in a multihop network and including a server and multiple nodes which transmit data to the server, wherein each of the nodes uses a private key shared with the server to calculate a tag as a message authenticator corresponding to the data, uses the tag to generate a parity tag composed of parities calculated as error-correcting code, and generates the parity tag corresponding to the tags created by the node and child nodes of the node, and transmits the parity tag to a parent node or the server together with the data.

### Advantageous Effects of Invention

According to the present invention, an increase in communication traffic due to tags can be reduced, and when an error has occurred due to the falsification of data or a mismatch between private keys, a node that has caused the error can be identified.

### BRIEF DESCRIPTION OF DRAWINGS

FIG. 1 It depicts a block diagram showing the configuration of an exemplary embodiment of a node used in a message authentication system according to the present invention.

FIG. 2 It depicts an explanatory diagram showing the structure of tags and parity tags.

FIG. 3 It depicts an explanatory diagram showing the input and output of parity tag generation means.

FIG. 4 It depicts a flowchart showing processing performed by the parity tag generation means to calculate a parity tag P(n), L(n).

FIG. 5 It depicts a block diagram showing the configuration of a server used in the message authentication system according to the present invention.

FIG. 6 It depicts a flowchart showing the operation of the exemplary embodiment of the node.

FIG. 7 It depicts a flowchart showing the operation of the exemplary embodiment of the server.

FIG. 8 It depicts an explanatory diagram showing the configuration of a multihop network in an example.

FIG. 9 It depicts a block diagram showing the configuration of a main part of a message authentication system according to the present invention.

FIG. 10 It depicts an explanatory diagram showing processing performed by a transmitter and a receiver in general message authentication.

FIG. 11 It depicts an explanatory diagram showing a configuration example of a multihop network.

FIG. 12 It depicts a block diagram showing a configuration example of a node using Aggregate MAC.

### DESCRIPTION OF EMBODIMENT

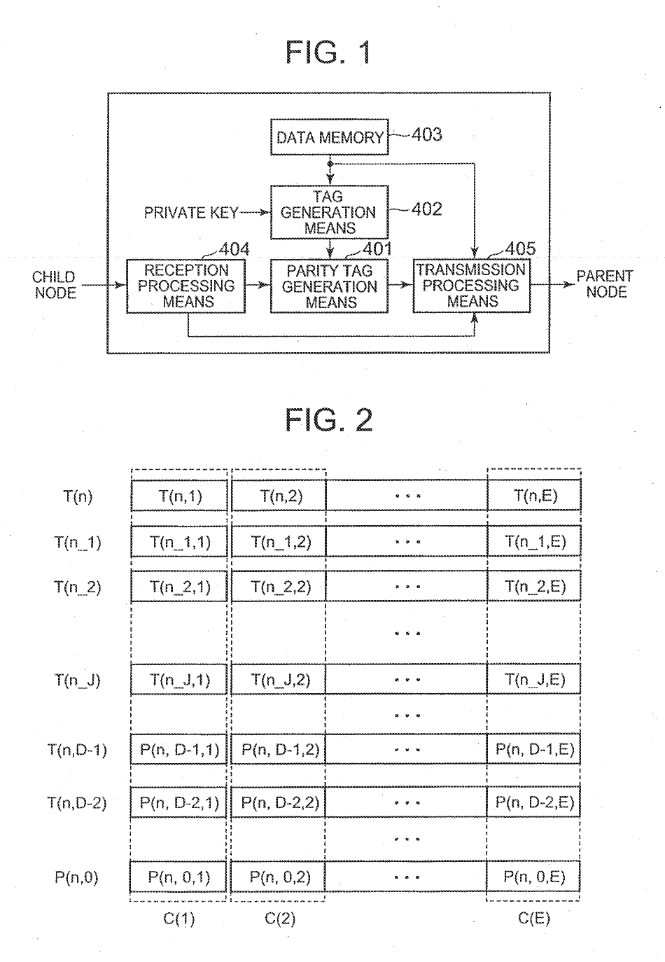

FIG. 1 is a block diagram showing the configuration of an exemplary embodiment of a node used in a message authentication system according to the present invention. The node used in the message authentication system includes parity tag generation means 401, tag generation means 402, a data memory 403, reception processing means 404, and transmission processing means 405. For example, these means are realized by hardware designed to perform specific arithmetic processing and the like, or implemented by an information processing device such as a CPU (Central Processing Unit) operating according to a program.

The reception processing means 404 receives data and a parity tag sent from a child node and extracts necessary information. The data memory 403 is a memory for storing data measured at the node. The tag generation means 402 generates a tag (authenticator) corresponding to the data using a private key, and transmits the generated tag together with the data. The parity tag generation means 401 generates a parity as error-correcting code. Specifically, the parity tag generation means 401 takes the input of parity tags of descendant nodes and a tag generated by the tag generation means 402 to generate a parity tag composed of parities. The transmission processing means 405 transmits data and the generated parity tag to a parent node (or a serve when the node is the uppermost node). Note that a child node may send a tag instead of the parity tag to a parent node under a predetermined condition. The condition will be described later.

Processing in each block shown in FIG. 1 at node n will be described below. It is assumed that the child nodes of node n are n_{—}1, . . . , n_J below. The reception processing means 404 receives and stores data DA(n_{—}1), . . . , DA(n_J) and tags Q(n_{—}1), . . . , Q(n_J) transmitted from the child nodes n_{—}1, . . . , n_J. The reception processing means 404 further receives tag T(n) generated by the tag generation means 402. Q(n_j) is tag T(n_j) of node n_j or parity tag P(n_j) generated by using tags of the descendant nodes. Further, the reception processing means 404 extracts the number of data (the number of nodes aggregated by node n_j) L(n_j) sent from the node n_j. L(n_j) is, for example, described in a header area of DA(n_j). When the node n_j is a terminal node of the network, Q(n_j)=T(n_j), L(n_j)=1.

The parity tag generation means 401 generates, as error-correcting code, a parity symbol for an information sequence composed of symbols whose number of bits is normally about m=1 to 16. The tag generally has a data length of 64 bits or more, and the tag is divided into symbols of the error-correcting code to generate a parity tag in the unit. Further, Like in Equation (3), it is assumed that tag T(n) is expressed by E m-bit symbols.

T(n)=(T(n,1), . . . ,T(n,E)). (3)

When the number of redundant symbols of error-correcting code is denoted by D, the parity tag generation means 401 generates a parity tag composed of D sequences of the same size as the tag. Parity tag P(n)=(P(n, 0), . . . , P(n, D−1)) corresponding to tags T(n), Q(n_{—}1), . . . , Q(n_J) of nodes n, n_{—}1, . . . , n_J is expressed as in Equation (4). In Equation (4), parities P(n, 0, e), . . . , P(n, D−1, e) (e=1, 2, . . . , E) of code word C(e) having tags of data corresponding to T(n, e), Q(n_{—}1, e), . . . , Q(n_J, e) as the information sequence are used. Further, in Equation (4), d=0, . . . , D−1.

P(n,d)=(P(n,d,1), . . . ,P(n,d,E)). (4)

FIG. 2 is an explanatory diagram showing the structure of tags and parity tags. There is a need to make D larger in order to enhance the capability of detecting and identifying the falsification of data of many nodes. However, there is a trade-off with the communication traffic of parity tags.

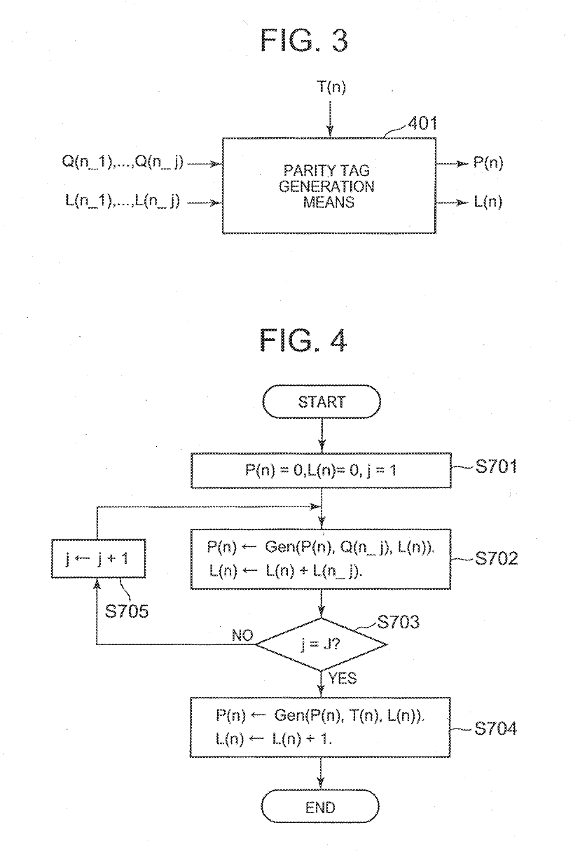

FIG. 3 is an explanatory diagram showing the input and output of the parity tag generation means 401. The parity tag generation means 401 takes the input of tags Q(n_{—}1), . . . , Q(n_J) and the number of data L(n_{—}1), . . . , L(n_J) sent from child nodes n_{—}1, . . . , n_J of the node n, and tag T(n) of the node n, and outputs parity tag P(n) and the number of data L(n) to the transmission processing means 405. Unlike Aggregate MAC as general technology, L(n_j) is required to generate a parity tag.

FIG. 4 is a flowchart showing processing performed by the parity tag generation means 401 to generate a parity tag P(n), L(n). This flow will be described below.

The parity tag generation means 401 performs initialization to set P(n)=0, L(n)=0, and index j=1 (step S701). Next, the parity tag generation means 401 updates P(n), L(n) using Q(n_j), L(n_j) as shown in Mathematical Expression (5) and Mathematical Expression (6) (step S702). In Mathematical Expression (5), Gen represents processing for updating the parity tag.

P(n)←Gen(P(n),Q(n_{—}j),L(n)). (5)

L(n)←L(n)+L(n_{—}j). (6)

When it becomes j=J and the parity tag generation means 401 determines that processing for the tags from the child nodes is completed (YES in step S703), the procedure proceeds to step S704, while if not (NO in step S703) j is updated (step S705), and the procedure returns to step 702. Next, the parity tag generation means 401 updates P(n) according to T(n) of the node n, and increments L(n) by one (step S704). When there is no need to transmit data measured at the node n, the parity tag generation means 401 skips step S704.

The transmission processing means 405 puts data received from nodes n_{—}1, . . . , n_J and data of the node n together to configure transmission data with L(n) put in the header, and transmits the data to the parent node together with parity tag P(n).

The error-correcting code used by the parity tag generation means 401 of the exemplary embodiment is required to have a property capable of using parities transmitted from the child nodes to generate a parity with tags of all the descendant nodes as an information sequence. The parity tag generation means 401 can use cyclic code typified by Reed-Solomon code as error-correcting code that satisfies such a property. Cyclic code on a Galois field GF(2̂m) uses a generator polynomial g(x)(degree D) having a coefficient in GF(2̂m) to generate a remainder polynomial R(x) for an information sequence (a(k), . . . , a(1)) (k<2̂m−D) like in the following Equation (7):

$$R ( x ) := R ( D - 1 ) {x}^{⋀} ( D - 1 ) + … + R ( 1 ) x + R ( 0 ) = ( a ( k ) {x}^{⋀} ( k + D ) + a ( k - 1 ) {x}^{⋀} ( k - 1 + D ) + … + a ( 1 ) {x}^{⋀} D ) mod g ( x ) . \qquad ( 7 )$$

In Equation (7), mod g(x) is an operation for taking a remainder when being divided by g(x), and D coefficients R=(R(0), R(1), . . . , R(D−1)) become parities of the remainder polynomial R(x). Parity tag P(n) is represented by E sets in the following (D−1) polynomial. Parity tag P(n)[x] in Equation (8) is expressed as a polynomial representation of P(n).

P(n)[x]:=P(n,D−1)x̂(D−1)+P(n,D−2)x̂(D−2)+ . . . +P(n,1)x+P(n,0). (8)

P(n,d)x̂j:=(P(n,d,1)x̂j,P(n,d,2)x̂j, . . . ,P(n,d,E)x̂j). (9)

It is also assumed that polynomial operations are performed symbol by symbol for T(n)x̂j, (P(n)[x]x̂j mod g(x)), etc. At this time, Mathematical Expression (5) for Q(n_j)=T(n_j) is represented as follows:

P(n)[x]←P(n)[x]+(T(n_{—}j)x̂(D+L(n)))mod g(x). (10)

On the other hand, Mathematical Expression (5) for Q(n_j)=P(n_j) is represented as follows:

P(n)[x]←P(n)[x]+(P(n_{—}j)[x]x̂L(n))mod g(x). (11)

In Mathematical Expression (10) and Mathematical Expression (11), the operation of mod g(x) can be carried out after P(n)[x] is updated up to n_{—}1, . . . , n_j.

In the above processing for using the cyclic code to generate parity tags, the parity tag generation means 401 can also use syndrome generation unless an error in or falsification of a parity tag on a communication channel is considered. When the primitive element of GF(2̂m) is denoted by α, the syndrome generation in the case of using Reed-Solomon code on GF(2̂m) carries out operations shown in the following Mathematical Expression (12) and Mathematical Expression (13) instead of Mathematical Expression (10) and Mathematical Expression (11):

P(n,d)←P(n,d)+T(n_{—}j)α̂(d·L(n)), (d=0,1, . . . ,D−1). (12)

P(n,d)←P(n,d)+P(n_{—}j,d)α̂(d·L(n))), (d=0,1, . . . ,D−1). (13)

In the multihop network, among nodes near the terminal in addition to the terminal nodes, intermediate nodes whose number of descendant nodes is smaller than or equal to the parity tag size (the number of symbols) D can also exist. In this case, it is advantageous to transmit a tag corresponding to data of each node as-is without generating a parity tag in terms of communication traffic. In FIG. 11, when D=3, node 2, node 4, and node 8 correspond to this case. In this case, node 2 transmits data DA(2), data DA(3) and tag T(2), tag T(3) of node 2 and node 3 as-is to node 1. The parent node can determine a tag or a parity tag based on the number of data. Node 1 can determine that tags are transmitted because the number of data received from node 2 and node 4 is two, that a parity tag is transmitted because the number of data from node 6 is five, and that a tag is transmitted because the number of data from node 12 is one. At this time, node 1 generates a parity tag from the tags of node 1, node 2, node 3, node 4, and node 5, the parity tag of node 6, and the tag of node 12.

In generating a parity tag, there is a need to be careful about the upper limit of the code length (information length) of error-correcting code to be applied. For example, the code length of Reed-Solomon code on GF(2̂m) is (2̂m−1) at most, and it is considered a method in which the parity tag generation means 401 performs control not to respond to nodes with code lengths exceeding this value. At this time, received data are grouped at an intermediate node to satisfy this condition to generate a parity tag.

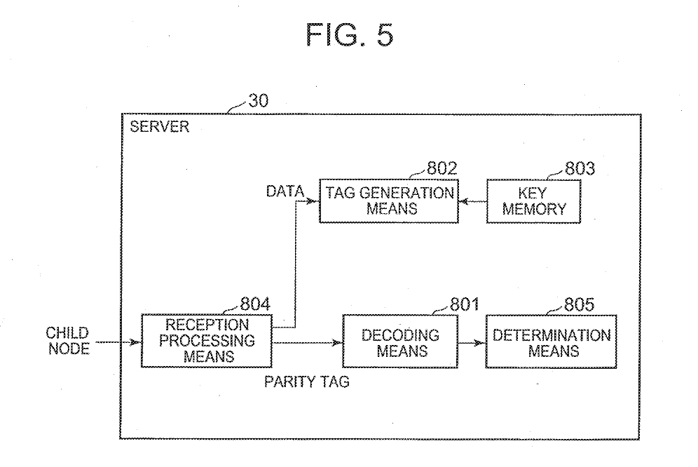

FIG. 5 is a block diagram showing the configuration of a server used in the message authentication system according to the present invention. A server 30 includes decoding means 801, tag generation means 802, a key memory 803, reception processing means 804, and determination means 805. For example, these means are realized by hardware designed to perform specific arithmetic processing, or by an information processing device such as a CPU (Central Processing Unit) operating according to a program.

The reception processing means 804 receives and stores data and parity tags sent from child nodes, and extracts necessary information. The key memory 803 stores a private key. The tag generation means 802 reads data of each node received by the reception processing means 804 to generate a tag using a corresponding private key stored in the key memory 803. The decoding means 801 performs decoding of error-correcting code from the tag generated by the tag generation means 802 and the received parity tag. Based on the result by the decoding means 801, the determination means 805 identifies a node corresponding to data in which corruption or an error has occurred. As mentioned above, a tag may be sent from a child node instead of the parity tag under a predetermined condition.

When the tag is composed of E symbols, the parity tag is composed of E parity symbols of error-correcting code C(1)-C(E). The decoding means 801 poses no problem to a tag with the decoding results of all received words corresponding to C(1)-C(E) determined not to be errors. Further, for example, when at least one received word is determined to be an error, the decoding means 801 determines that an error has occurred due to the falsification of data corresponding to the tag, a mismatch between private keys, or the like. The decoding means 801 may output a message indicating that the decoding is unsuccessful. In this case, it is determined that errors have occurred in data of all nodes due to the falsification of the data, a mismatch between private keys, or the like.

An appropriate number of parity symbols is determined depending on the number of nodes in the network. Therefore, it is considered that the number of parity symbols is increased for a network composed of a large number of nodes. Since the multihop network is configured in an ad hoc manner and it is assumed that the network configuration dynamically varies, the server changes the number of parity symbols according to the size of the network, and notifies corresponding nodes thereof.

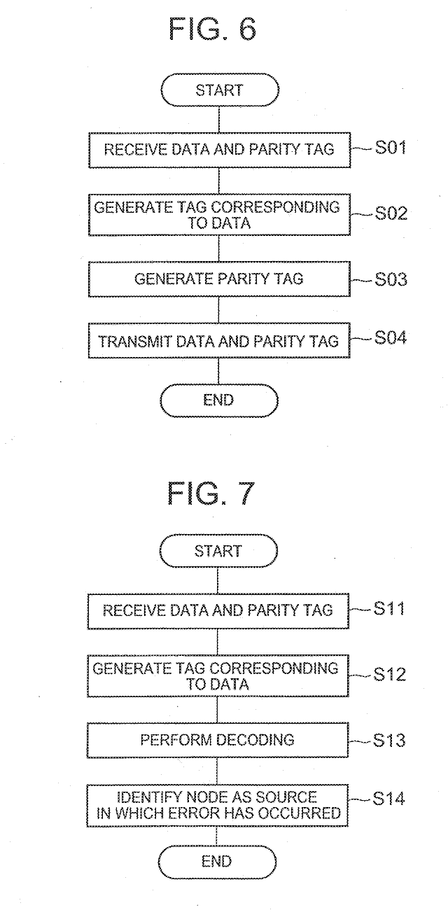

Next, the operation of a node in the message authentication system of the exemplary embodiment will be described. FIG. 6 is a flowchart showing the operation of the exemplary embodiment of a node. The reception processing means 404 receives data and a parity tag sent from a child node, and extracts necessary information (step S01). The tag generation means 402 uses a private key to generate a tag (authenticator) corresponding to the data, and transmits the generated tag together with data (step S02). The parity tag generation means 401 generates a parity as error-correcting code (step S03). Specifically, the parity tag generation means 401 takes the input of parity tags of descendant nodes and the tag generated by the tag generation means 402 to generate a parity tag composed of parities. The transmission processing means 405 transmits the data and the generated parity tag to a parent node (step S04).

Next, the operation of the server in the message authentication system of the exemplary embodiment will be described. FIG. 7 is a flowchart showing the operation of the exemplary embodiment of the server. The reception processing means 804 receives and stores data and parity tags sent from child nodes, and extracts necessary information (step S11). The tag generation means 802 reads data of each node received by the reception processing means 804, and generates a tag using a corresponding private key stored in the key memory 803 (step S12). The decoding means 801 performs decoding of error-correcting code from the tag generated by the tag generation means 802 and the received parity tags (step S13). Based on the decoding results by the decoding means 801, the determination means 805 identifies a node as the source of data in which an error has occurred (step S14). For example, this error includes an error due to a mismatch between private keys, and an error caused by an illegal operation such as the falsification of data.

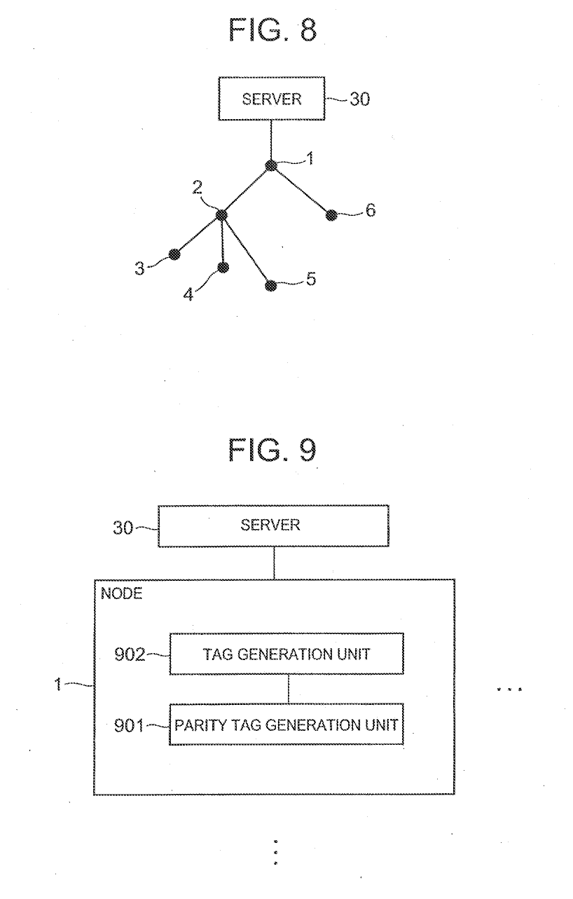

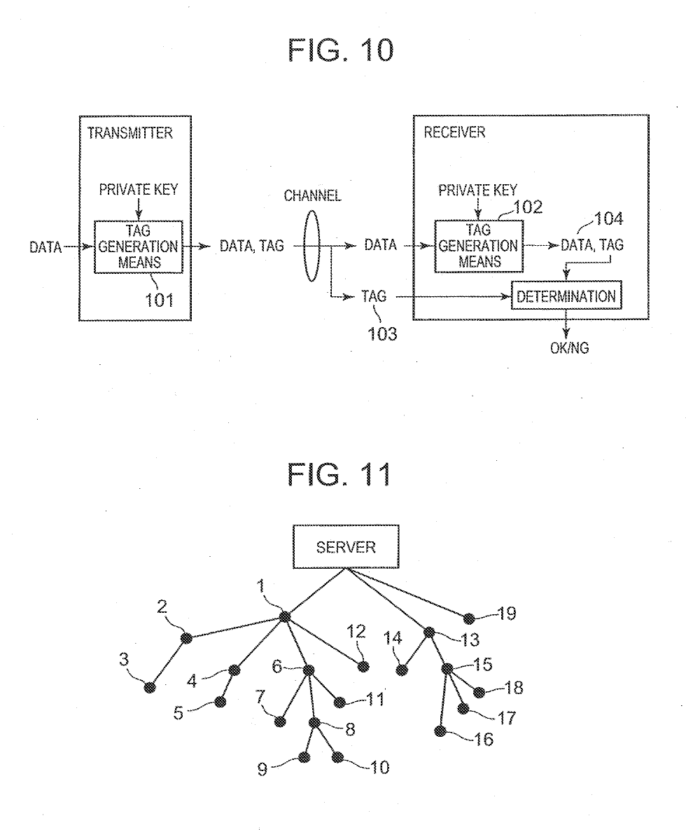

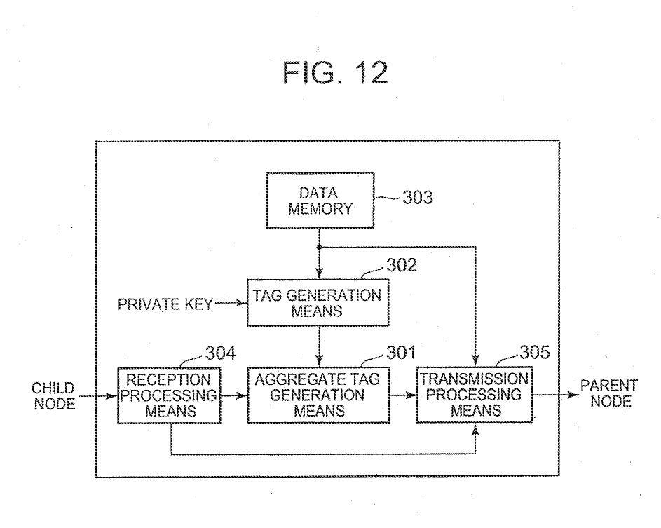

Next, an example of a message authentication system according to the present invention will be described. FIG. 8 is an explanatory diagram showing the configuration of a multihop network using the message authentication system in the example. In FIG. 8, node 1 is a parent node. Further, in the example, Reed-Solomon code is used as error-correcting code. It is also assumed that the error-correcting code to be applied is Reed-Solomon code on a Galois field GF(2̂8) (m=8). The primitive polynomial of GF(2̂8) is expressed, for example, like in the following Equation (14):

p(x)=x̂8+x̂4+x̂3+x̂2+1. (14)

Each symbol of GF(2̂8) is expressed as a (binary) polynomial equation (the maximum degree is 7) on GF(2), where addition is a bitwise exclusive OR, and multiplication is performed by taking a mod to a product of polynomials when being divided by p(x). When the number of parity symbols is D=3, the generator polynomial g(x) of the Reed-Solomon code is expressed as the following Equation (15):

g(x)=(x+α)(x+α̂2)(x+α̂3). (15)

This code has the capability of correcting a one-symbol error and detecting two-symbol errors. In the message authentication system in the exemplary embodiment, this code is so applied that, when the falsification of data or a mismatch between private keys has occurred in one node, it can be identified in which node the falsification or the mismatch has occurred. When the falsification of data or errors have occurred in two nodes, it is determined that decoding is impossible (detection only), and the server 30 performs processing, for example, for requesting retransmission from all the nodes.

When the tag length is 96 bits, one tag is composed of E=96/8=12 symbols in the error-correcting code of symbols with m=8 bits.

The operation of processing by nodes and the server in the example will be described below. In the example, it is assumed that the tag length is 64 bits.

First, an example of processing by nodes will be described. The terminal node 3, node 4, and node 5 in FIG. 8 transmit, to node 2 as the parent node, pairs of data and tags (DA(3), T(3)),(DA(4), T(4)), and (DA(5), T(5)), respectively. Since the number of descendant nodes (including the own node) exceeds D=3, node 2 generates parity tag P(2). Further, L(3)=L(4)=L(5)=1. P(2) can be expressed by the following polynomial equation (16):

P(2)[x]=(T(2)x̂6+T(5)x̂5+T(4)x̂4+T(3)x̂3)mod g(x). (16)

The parity tag generation means 401 calculates P(2) based on Mathematical Expression (6), Mathematical Expression (10), and Mathematical Expression (11) as follows:

node 3: P(2)[x]←T(3)[x]x̂3 mod g(x),L(2)←1,

node 4: P(2)[x]←P(2)[x]+T(4)x̂(1+3)mod g(x),L(2)←2,

node 5: P(2)[x]←P(2)[x]+T(5)x̂(2+3)mod g(x),L(2)←3, and

node 2: P(2)[x]←P(2)[x]+T(2)x̂(3+3)mod g(x),L(2)←4. (17)

Node 2 transmits, to the server, L(2)=4, data DA(2), data DA(5), data DA(4), data DA(3), and parity tag P(2). Child nodes of node 1 are node 2 and node 6. Node 1 receives data DA(2), data DA(5), data DA(4), data DA(3), and parity tag P(2) from node 2, and receives data DA(6) and tag T(6) from node 6. L(2)=4 and L(6)=1, and the parity tag generation means 401 calculates P(1) based on Mathematical Expression (6), Mathematical Expression (10), and Mathematical Expression (11) as follows:

node 2: P(1)[x]←P(2)[x]x̂0 mod g(x)=P(2)[x],L(1)←4,

node 6: P(1)[x]←P(1)[x]+T(6)x̂(4+3)mod g(x),L(1)←5, and

node 1: P(1)[x]←P(1)[x]+T(1)x̂(5+3)mod g(x),L(1)←6. (18)

P(1) [x] matches the following parity tag:

P(1)[x]=(T(1)x̂8+T(6)x̂7+T(2)x̂6+T(5)x̂5+T(4)x̂4+T(3)x̂3)mod g(x). (19)

Node 1 transmits, to the server, L(1)=6, data DA(1), data DA(6), data DA(2), data DA(5), data DA(4), and data DA(3).

Next, processing by the server 30 in the example will be described. In the server 30, it is assumed that received data corresponding to nodes 1-6 are denoted by DA′(1)-DA′(6), and the received parity tag is denoted by P′(1). The server first uses private keys of respective nodes to generate tag T′(1)-T′(6) from DA′(1)-DA′(6). The decoding means 801 performs decoding of the Reed-Solomon code on received words (e=1, 2, . . . , 8) shown in Equation (20).

C′(e)=(T′(1,e),T′(6,e),T′(2,e),T′(5,e),T′(4,e),T′(3,e),P′(1,2,e),P′(1,1,e),P′(1,0,e)) (20)

Normal methods based on the Euclidean algorithm and the like can be applied to the decoding of Reed-Solomon code. When D parity symbols are added, these decoding methods can identify D/2 error symbols or less.

When no falsification or error exists in data and tags, C′(e) is decoded without any error in all e. On the other hand, for example, when DA′(2)≠DA(2) and DA(2) has been falsified, T′(2, e)≠T(2, e) on at least one e with a very high probability by the nature of message authentication. If there is no error due to the falsification of any other data or parity tag, or a mismatch between private keys, the decoding of the Reed-Solomon code will end up outputting such a decoding result that the third symbol in Equation (20) is an error symbol. The determination means 805 can identify node 2 as the node corresponding to the third symbol to determine that falsification or a mismatch between private keys has occurred in this node.

Based on this determination, for example, the server 30 gives responses shown in the following (1) to (4):

(1) Makes a request to only node 2 to retransmit data.
(2) Figures out the cause of the error in node 2.
(3) Changes the network configuration so that node 2 will not have any child node.
(4) Controls the tag of node 2 not to be added to the generation of the parity tag.

The message authentication system of the exemplary embodiment can reduce tag communication traffic compared to normal methods of transmitting tags of all nodes without any change. For example, when a common system is used, the volumes of transmission data on the tags of node 6 and node 1 in FIG. 11 are 6 and 12 as the numbers of tags, respectively. On the other hand, the message authentication system of the exemplary embodiment can reduce the volumes to a given number (=the size D of the parity tag). Further, when D=3 in FIG. 11, the volumes of transmission data on the tags of node 6 and node 1 become ½ and ¼ by the message authentication system of the exemplary embodiment. On the other hand, when the falsification of data of one node in the network or an error in private key has occurred, the use of Reed-Solomon code with D=3 can identify the corresponding node from the decoding result.

As described above, when an error due to falsification or a mismatch between private keys has occurred, the message authentication system of the exemplary embodiment can reduce the volume of transmission data on message authentication tags of the multihop network while maintaining the function of identifying a node as the cause of the error.

FIG. 9 is a block diagram showing the configuration of a main part of a message authentication system according to the present invention. As shown in FIG. 9, the message authentication system according to the present invention is a message authentication system used in a multihop network and including a server 30 and multiple nodes 1 which transmit data to the server 30. Each of the nodes 1 includes: a tag generation unit 902 which uses a private key shared with the server to calculate a tag as a message authenticator corresponding to the data; and a parity tag generation unit 901 which uses the tag to generate a parity tag composed of parities calculated as error-correcting code, wherein the node 1 generates the parity tag corresponding to the tags created by the node 1 and child nodes of the node 1, and transmits the parity tag to a parent node or the server together with the data.

In the aforementioned exemplary embodiment, message authentication systems shown in (1) to (6) below are also disclosed.

(1) A message authentication system used in a multihop network and including a server 30 and multiple nodes (e.g., nodes 1 to 6) which transmit data to the server 30, wherein each of the nodes includes: tag generation means (e.g., the tag generation means 402) for using a private key shared with a server (e.g., the server 30) to calculate a tag as a message authenticator corresponding to the data; and parity tag generation means (e.g., the parity tag generation means 401) for using the tag to generate a parity tag composed of parities calculated as error-correcting code, wherein a node (e.g., node 2) generates the parity tag corresponding to tags created by the node and child nodes (e.g., node 3, node 4, and node 5) of the node, and transmits the parity tag to a parent node (e.g., node 1) or the server together with the data.

(2) The message authentication system may be configured such that the parity tag generation means takes the input of parity tags of the child nodes to generate a parity tag using an encoding process of cyclic code or a syndrome generation process.

(3) The message authentication system may also be configured such that, when the number of tags to be used to generate a parity tag is smaller than or equal to the number of parity symbols of the error-correcting code, the node transmits tags created by the node and the child nodes of the node instead of the parity tag. According to this message authentication system, an increase in communication traffic can be reduced when the number of nodes is small.

(4) The message authentication system may further be configured such that the parity tag generation means generates the parity tag to make the number of tags, used to generate one parity tag, smaller than or equal to the maximum value of an information length of the error-correcting code.

(5) Further, the message authentication system may be configured such that the server includes: tag generation means for using a private key shared with each node to calculate a tag as a message authenticator corresponding to received data; decoding means for using a received parity tag and the tag to perform decoding of error-correcting code; and determination means for identifying a node corresponding to a tag determined to be an error by the decoding means.

(6) Further, the message authentication system may be configured such that the server determines and notifies nodes of the number of parity symbols of the error-correcting code according to the number of nodes.

This application is based upon and claims the benefit of priority from Japanese patent application No. 2012-249559, filed on Nov. 13, 2012, the disclosure of which is incorporated herein in its entirety by reference.

While the present invention has been described with reference to the exemplary embodiment (and the example), the present invention is not limited to the aforementioned exemplary embodiment (and the example). Various changes understandable to those skilled in the art can be made to the configuration and details of the present invention within the scope of the present invention.

### INDUSTRIAL APPLICABILITY

The present invention can be applied to a multihop network composed of sensors and the like.

### REFERENCE SIGNS LIST

1-6 node
30 server
401 parity tag generation means
402, 802 tag generation means
403 data memory
404, 804 reception processing means
405 transmission processing means
801 decoding means
803 key memory
805 determination means
901 parity tag generation unit
902 tag generation unit

1. A message authentication system used in a multihop network and including a server and a plurality of nodes which transmit data to the server, wherein each of the node includes:
tag generation unit which uses a private key shared with the server to calculate a tag as a message authenticator corresponding to the data; and
parity tag generation unit which uses the tag to generate a parity tag composed of parities calculated as error-correcting code,
wherein the node generates the parity tag corresponding to the tags created by the node and child nodes of the node, and transmits the parity tag to a parent node or the server together with the data.

2. The message authentication system according to claim 1, wherein the parity tag generation unit takes input of parity tags of the child nodes to generate a parity tag using an encoding process of cyclic code or a syndrome generation process.

3. The message authentication system according to claim 1, wherein when the number of tags to be used to generate a parity tag is smaller than or equal to the number of parity symbols of the error-correcting code, the node transmits tags created by the node and the child nodes of the node instead of the parity tag.

4. The message authentication system according to claim 1, wherein the parity tag generation unit generates the parity tag to make the number of tags, used to generate one parity tag, smaller than or equal to a maximum value of an information length of the error-correcting code.

5. The message authentication system according to claim 1, wherein the server includes:
tag generation unit which uses a private key shared with each node to calculate a tag as a message authenticator corresponding to received data;
decoding unit which uses a received parity tag and the tag to perform decoding of error-correcting code; and
determination unit which identifies a node corresponding to a tag determined to be an error by the decoding unit.

6. The message authentication system according to claim 1, wherein the server determines the number of parity symbols of the error-correcting code according to the number of nodes, and notifies the nodes thereof.

7. A message authentication method used in a message authentication system used in a multihop network and including a server and a plurality of nodes which transmit data to the server, comprises
using a private key shared with the server to calculate a tag as a message authenticator corresponding to the data,
using the tag to generate a parity tag composed of parities calculated as error-correcting code, and
generating the parity tag corresponding to the tags created by the node and child nodes of the node, and transmitting the parity tag to a parent node or the server together with the data.

8. The message authentication system according to claim 2, wherein when the number of tags to be used to generate a parity tag is smaller than or equal to the number of parity symbols of the error-correcting code, the node transmits tags created by the node and the child nodes of the node instead of the parity tag.

9. The message authentication system according to claim 2, wherein the parity tag generation unit generates the parity tag to make the number of tags, used to generate one parity tag, smaller than or equal to a maximum value of an information length of the error-correcting code.

10. The message authentication system according to claim 3, wherein the parity tag generation unit generates the parity tag to make the number of tags, used to generate one parity tag, smaller than or equal to a maximum value of an information length of the error-correcting code.

11. The message authentication system according to claim 2, wherein the server includes:
tag generation unit which uses a private key shared with each node to calculate a tag as a message authenticator corresponding to received data;
decoding unit which uses a received parity tag and the tag to perform decoding of error-correcting code; and
determination unit which identifies a node corresponding to a tag determined to be an error by the decoding unit.

12. The message authentication system according to claim 3, wherein the server includes:
tag generation unit which uses a private key shared with each node to calculate a tag as a message authenticator corresponding to received data;
decoding unit which uses a received parity tag and the tag to perform decoding of error-correcting code; and
determination unit which identifies a node corresponding to a tag determined to be an error by the decoding unit.

13. The message authentication system according to claim 4, wherein the server includes:
tag generation unit which uses a private key shared with each node to calculate a tag as a message authenticator corresponding to received data;
decoding unit which uses a received parity tag and the tag to perform decoding of error-correcting code; and
determination unit which identifies a node corresponding to a tag determined to be an error by the decoding unit.

14. The message authentication system according to claim 2, wherein the server determines the number of parity symbols of the error-correcting code according to the number of nodes, and notifies the nodes thereof.

15. The message authentication system according to claim 3, wherein the server determines the number of parity symbols of the error-correcting code according to the number of nodes, and notifies the nodes thereof.

16. The message authentication system according to claim 4, wherein the server determines the number of parity symbols of the error-correcting code according to the number of nodes, and notifies the nodes thereof.

17. The message authentication system according to claim 5, wherein the server determines the number of parity symbols of the error-correcting code according to the number of nodes, and notifies the nodes thereof.
